(19) United States
(12) Patent Application Publication
(10) Pub. No.: US 2005/0074508 A1
(43) Pub. Date: Apr. 7, 2005

(54) Compositions and methods based on exracts of quillaja saponaria molina for controlling nematodes

(76) Inventor: Ricardo San Martin, Santiago (CL)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/642,155

(22) Filed: Aug. 18, 2003

(30) Foreign Application Priority Data
Dec. 3, 2002 (CL) 2772-2002

(51) Int. Cl. A01N 65/00

(52) U.S. Cl. 424/753

(57) ABSTRACT

A method for the control of plant parasitic nematodes, comprising applying an extract of Quillaja saponin Molina, a product for the control of plant parasitic nematodes present in agricultural crops, comprising an aqueous extract from Quillaja saponaria Molina, said extract comprising a saponin fraction with 2 to 14% by weight of said fraction of saponin, and a non saponin fraction with at least 5% of said fraction of polyphenols.

The present invention relates to a product for the control of plant parasitic nematodes and to the method of application of same in agriculture, the product being manufactured based on extracts from the Chilean tree Quillaja saponaria Molina (quillaja). Said product contains saponins, polyphenols, salts and sugars from the quillaja extract. The method comprises the application of the product to the agricultural area, with the object of controlling plant parasitic nematodes present in the soil. An important aspect of the invention is that it was possible to establish that the nematicidal effect is due to synergy between the saponins and the other compounds present in the extract. When used separately, the saponin and the non saponin fractions of the extract do not exhibit important nematicidal effects. Only the joint use of both fractions results in a nematicidal effect at economically feasible dosages.

### BACKGROUND OF THE INVENTION

Nematodes cause important losses to agriculture. Worldwide crop losses due to the nematode Meloidogyne and other nematodes amount to approximately 15%. This percentage is not distributed equitably: most of the losses affect small developing countries. Their losses may reach 25% to 50% in large agricultural land areas. Presently, the damage produced by nematodes to the worldwide crop production is quite significant. In the United States of America, agricultural crop yearly losses amount to US$ 8 billion, and throughout the world, to an estimate of US$ 78 billion/year. For example, in northern United States the soy production suffered a loss of US$ 267 million in 1998.

There are very few authorized chemical nematicides. The few available products are highly toxic and their use permits are under constant revision. The following chemical nematicides are among those most commonly used:
1. Aliphatic halogenated hydrocarbons. Methyl bromide, ethylene dibromide.
2. Methyl isothiocyanate releasers. Dazomet (Basamid).
3. Organophosphorus compounds. Fenamiphos (Nemacur, Bayer), ethoprophos (Mocap, Rhone Poulenc) or thiozine.
4. Carbonates: Aldicarb (Temik, Rhone Poulenc), oxamyl (Vydate, Du Pont) and methylcarbonates, for example: carbofuran (Furadan, Hoetsch).

The products classified in Groups 1 and 2 are basically fumigants which diffuse in the soil in the form of gases. Groups 3 and 4 correspond to non volatile or non fumigant nematicides, which require to be mixed into the soil.

Two widely used products: fenamiphos (Nemacur, Bayer) and methyl bromide will be withdrawn from the international market in the near future, due to their high toxicity. Methyl bromide will be gradually withdrawn from the market: a 50% reduction in 2001, a 70% reduction in 2003 and a 100% reduction in 2005. Nemacur will be partially withdrawn from the market in 2005, and completely in 2007.

As a way of solving this problem, nematicides of natural origin have been developed. However, their use is limited by their high price and, in some cases, by their low efficacy. For example, in the Chilean market there exists the product DITERA, which is obtained by fermentation of a fungus having nematicidal effects. However, this product has an application cost per hectare which is 50-70% higher than the cost of the chemicals.

Among the natural alternatives for nematode control, there is the use of saponins and polyphenols. Both saponins and polyphenols are widely distributed throughout the vegetable kingdom.

Saponins are natural surfactants capable of permeating the walls of plants and microorganisms due to their association with the sterols present in cell membranes. Their chemical structure consists of a hydrophobic core (aglycone) to which are bonded sugar chains of a hydrophilic nature. There are two main types of saponins according to the chemical structure of the aglycone: triterpene saponins (wherein the core is a triterpene) and steroid saponins (wherein the core is a steroid). The industrial sources of triterpene and steroid saponins are the extracts of Yucca schidigera and Quillaja saponaria Molina, respectively.

The present invention relates to a product based on extracts from Quillaja saponaria Molina for the control of plant parasitic nematodes, and to the associated method of application of same. Triterpene saponins from quillaja have, as a basic structure, the quillaic acid triterpene, substituted at the 3-C position with a di-or tri-saccharide and at the 28-C position, with an oligosaccharide through a fucose residue, to which are bonded one or two acyl groups (see FIG. 1). The different saccharides and oligosaccharides give origin to at least 100 different types of quillaja saponins, characterized by nuclear magnetic resonance (Nors. L., Kenne, L. and Jacobson, S. (2001). Multivariate analysis of 1H NMR spectra for saponins from Quillaja saponaria Molina. Analytica Chimica Acta, 446: 199-209). The purity and concentration of the saponins can be assessed by high performance liquid chromatography (San Martin, R. and Briones, R. (2000). Quality control of commercial quillaja (Quillaja saponaria Molina) extracts by reverse phase HPLC. Journal of the Science of Food and Agriculture, 80: 2063-2068).

The extract is obtained from the whole biomass of the quillaja tree, as described in Chilean Patent Application No. 2573-2002, and contains saponins, polyphenols, salts and sugars.

The crude aqueous quillaja extract can be fractioned by ultrafiltration into a saponin-rich fraction (FS, saponin fraction) and another fraction which contains all the other soluble compounds from quillaja (FNS, non saponin fraction). This fractioning is based on the fact that saponins form high molecular weight aggregates (micelles) which are retained by the ultrafiltration membranes, while the low molecular weight solids pass across the membranes.

The fractioning of the quillaja extract is performed on an industrial basis. The saponin-rich fraction has important industrial applications, such as the suppression of the acid mist in copper electro-winning cells (Chilean Patent Application No. 1869-2002), as well as in the photographic industry. The non saponin fraction obtained from this purification process is a byproduct with no direct commercial value. The cost of production of the non saponin fraction is estimated to be 8-10 times lower than the cost of the crude extract.

There are several previous reports on the use of saponin-rich extracts for nematode control, particularly steroid-type saponins derived from Yucca schidigera. The product Pent-A-Vate, commercialized in the U.S.A., is comprised of saponins from Y. schidigera, and is sold to control nematode populations, especially Meloidogyne. The manufacturer specifies that the product used on its own is only capable of reducing the populations by 40%-50%. However, when mixed with fish oil or another natural oil, the nematode populations can decrease drastically by 85%-95%.

U.S. Pat. No. 5,639,794 relates to the use of saponins in methods and compositions for pathogen control. Saponin, in association with natural products especially aromatic aldehydes, shows strong synergy when it is tested for controlling the growth of plant and animal pathogens, such as fungi, insects, arachnids and non aquatic mollusks. The product may be applied before, during or after sowing and harvesting, since it is non toxic and non contaminant. One of the examples of the patent reports the use of steroidal saponins from the Mexican plant yucca (Yucca schidigera) for nematode control. The corresponding claim states that the yucca saponin per se exerts control of root-knot nematodes (Meloidogyne javanica), achieving the same rates as when conjugated with natural products. The patent is based only on in vitro (laboratory) experiments and not on field treatments.

There is also information about extracts from acacia containing saponins as nematicides. Laboratory experiments indicate that crude acacia extracts, at a concentration of 4,000 ppm, is capable of killing 55% of the Meloidogyne incognita juvenile nematodes in 80 minutes.

U.S. Pat. No. 5,595,748 describes the use of polyphenols for nematode control. It is disclosed that the nematodes are attracted by polyphenols at low concentrations (<10,000 ppm), there being observed a nematicidal effect only at high concentrations (10,000 ppm-100,000 ppm).

The present invention patent evidences, through the examples disclosed, that purified triterpene-type saponins from quillaja exert nematode control with phytosanitary significance only at high doses. However, as a great advantage of the present invention over the previous art, we were able to establish that when these saponins are applied in combination with the other components of quillaja extracts (sugars, salts, polyphenols present in the non saponin solids), there occurs a synergistic effect which permits to control nematodes by application of economically feasible dosages of the product. Consequently, the product disclosed in the invention corresponds to a combination of saponin containing solids and non saponin containing solids, resulting in a product having a high nematicidal power at a most convenient cost. There is also provided the method of applying said products in order to achieve the best results.

### SUMMARY OF THE INVENTION

It is an object of the present invention to provide a product for the control of plant parasitic nematodes and the method of application of same in agriculture, the product being manufactured from extracts from the Chilean native tree Quillaja saponaria Molina (quillaja). Said product contains saponins, polyphenols, salts and sugars from the quillaja extract, and a method that comprises the application of the product in the agricultural area, in order to control the plant parasitic nematodes present in the soil. The product is based on the aqueous extracts from Quillaja saponaria Molina (quillaja), preferably through the association of the saponin fraction with the non saponin fraction, both contained in the total solid fraction present in said aqueous extract from quillaja.

### BRIEF DESCRIPTION OF THE DRAWING

FIG. 1 represents the molecular structure of representative triterpene saponins contained in quillaja.

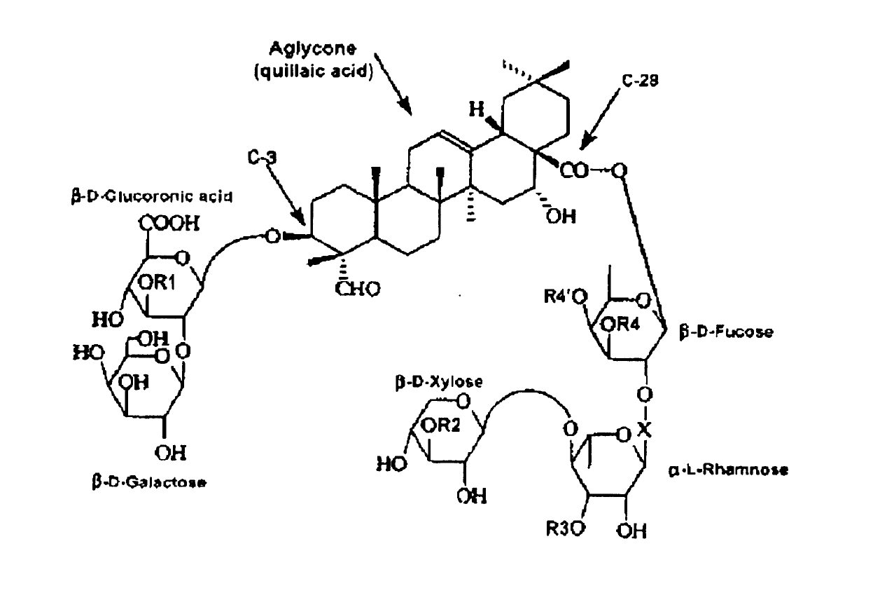

### DETAILED DESCRIPTION OF THE INVENTION

The product intended for nematode control obtained from the extract of Quillaja saponaria Molina (quillaja) preferably contemplates an association, e.g., in well-defined ranges, of the saponin fraction with the non saponin fraction, both being contained in the total solid fraction present in the quillaja liquid extract. This association of both fractions, e.g., in precise ranges, as herein below disclosed in the examples, is mainly related to the fact that, with a highly refined product in which only the saponin fractions are used, the results obtained for nematode control are practically null. This fact contradicts the first paradigm of the state of the art. Likewise, the use of an extract containing only the non saponin fraction does not result in a successful effect regarding nematode control. Thus, in the tests performed, it was established that a product combining extracts having both fractions resulted in a high nematode control and, depending on the time of action of the product after being applied, the mortality of said nematodes was practically complete.

The product may be manufactured in the form of several combinations, wherein the concentration of the quillaja aqueous extract ranges, e.g., from 100 g solids/liter to 550 g solids/liter. This range of the solid fraction contains all the soluble solids of quillaja: saponins, polyphenols, sugars and salts. In this product, the saponin concentration ranges from 2% to 14%, preferably 2% to 12% w/w, which is determined by reverse phase HPLC, according to the method described by San Martin and Briones. In the examples, this product will be referred to as XC-1. This first product comprises both fractions, saponins and non saponins, on its own, but has the drawback that although it is a powerful controller of nematodes, its cost is high.

The second product combination comprises a mixture of the quillaja aqueous extract XC-1 with a quillaja aqueous extract designed XC-NS which contains only the non saponin fraction. The solids content of XC-NS is from 500 g/l to 600 g/l, and its polyphenol content is higher than 5% w/w.

The product formulations based on the combination of XC-1 with XC-NS comprise ranges in which XC-1 is incorporated at a solids concentration ranging from 100 g/l to 550 g/l, a concentration of 350 g/l being preferably employed; and XC-NS is also incorporated at a concentration of 350 g/l, such that a prepared product is obtained having, e.g., 80% to 90% w/w of XC-1 and 10% to 20% w/w of XC-NS. The product obtained by combination of XC-1 with XC-NS is substantially less expensive than XC-1 used alone and, as will be verified in the examples, the results are as good as those initially obtained for XC-1 alone, thus making this combination a highly attractive alternative for the agricultural market.

We also evaluated the use of a quillaja aqueous extract purified by ultrafiltration which basically contains quillaja saponins with some minor impurities, designated XC-Ultra, wherein the solids concentration ranges from 150 g/l to 250 g/l, and its saponin content is in the range of 13.5% and 23%. This test illustrates and demonstrates that the use of saponins on their own does not achieve the control of nematodes at all, thus radically contradicting the paradigm that had been accepted as true before the present invention.

The method of the invention comprises the application of products based on quillaja extract in order to control plant parasitic nematodes, wherein said products may, preferably but not exclusively, be the above described XC-1 and XC-1+XC-NS, in variable amounts depending on the type of nematode to be controlled and the soil conditions. Additionally, in tests applying pure quillaja extract, without further filtration and having similar characteristics to XC-1 regarding the solids present in the aqueous extract but a greater amount of impurities, the results were equally good.

The applications comprised similar dosages for all the products. Volumes ranging between 10 and 40 liters of product per hectare of land were applied, there being observed very good results for the application of XC-1+XC-NS having a solids concentration of 350 g/l, prepared with 85% w/w XC-1 and 15% w/w XC-NS, in amounts ranging from 25 to 35 liters per hectare. Applications were also performed with XC-1+XC-NS having a solids concentration of 350 g/l, prepared with 90% w/w XC-1 and 10% w/w XC-NS, which succeeded in reducing the nematodes, however the results were not as good as in the former application.

It is important to mention that when carrying out the method, it was not only demonstrated that the application of the product based on quillaja extract reduced the plant parasitic nematodes to a minimum, but also the fruit production was enhanced because the reduction of the nematodes substantially increased plant vigorousness.

The products are generally applied through the irrigation systems installed in the plantation fields, whereby the product is diluted in the irrigation water depending on the particular needs of each plantation. The application of the product, as disclosed herein below in the examples, contemplates dosages ranging from 50 ppm to 10,000 ppm or higher, depending on the dilution applied.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing and in the examples, all temperatures are set forth uncorrected in degrees Celsius and, all parts and percentages are by weight, unless otherwise indicated.

The entire disclosure of all applications, patents and publications, cited herein and of Chilean priority application No. 2772-2002, filed Dec. 3, 2002 are incorporated by reference herein.

### EXAMPLES

### Example 1

### Evaluation of the Nematicidal Action of Different Quillaja Extracts: Extracts XC-1, XC-Ultra and XC-NS

Under laboratory conditions, the three types of extracts produced were assayed, the characteristics of which were already described under “Description of the Invention”. Extract XC-1 was applied at a concentration of 550 g solids/liter.

The different nematode species were obtained from different locations in Chile. Meloidogyne hapla was obtained from the Santa Carolina vineyards in Casablanca (Central Region), Xiphinema index was obtained from the Agrofrío vineyards in Copiapó (Northern Region), and Pratylenchus thornei, Pratylenchus sp, Tylenchorhynchus sp, and Helicotylenchus sp were obtained from the Santa Carolina vineyards in Buin (Central Region).

The nematodes were distributed by placing at least 30 specimens of each type in Petri dishes and in 40-ml flasks with threaded lids. The temperature during the assay ranged from 17.5° C. to 19° C. Then, they were decanted, concentrated and transferred by means of a nematologic rod to the flasks with the different saponin solutions. Blank samples for all the nematode species contained distilled and deionized water.

For the highest concentrations (10,000 ppm product up to pure product) Petri dishes were used. This was because the viscosity of the extracts hampered the transfer of the nematodes in solution to the counting dishes. 5 replicates were run for each concentration and for each nematode species.

Viability was assessed every 24 hours during 3-10 days. In order to assess viability, a stereoscopic microscope was employed, with magnifications of 50 and 1000×. Viability of individuals was determined according to the table of morphological characteristics used to assess viability of second stage young cyst nematodes, from the Heteroderidae family. The characteristics used were: a) Movement, b) Pigmentation, c) Body shape, d) Pressure of the pseudocoelomic liquid, e) Response to contact stimuli.

Nematodes classified as dead were taken from the solution and transferred to a vessel containing distilled water. These vessels contained only the specimens corresponding to that treatment, that replicate and that day. The latter was in order to be able to confirm mortality of these specimens at 24, 48 and 72 hours, thus discarding a possible nemostatic action of the product. After being in distilled water for 72 hours from the moment when they were classified as dead, and did not show recovery, they were definitively classified as dead.

Table 1 shows the mortality percentage of nematodes with 100 ppm of each product at different contact times. This concentration was used for being economically feasible. This means that the application costs of the products are comparable to those of the chemicals currently used to control nematodes.

TABLE 1
Mortality percentage of nematodes under laboratory
conditions. Product dosage: 100 ppm.

| Nematode | Time (h) | XC-Ultra | XC-NS | XC-1 |
|---|---|---|---|---|
| Xiphinema index | 24 | 0% | 0% | 40% |
| | 48 | 0% | 0% | 100% |
| | 72 | 0% | 0% | |
| Meloidogyne hapla | 24 | 0% | 0% | 20% |
| | 48 | 0% | 0% | 67% |
| | 72 | 0% | 0% | 100% |
| Pratylenchus thornei | 24 | 0% | 0% | 30% |
| and Pratylenchus | | | | |
| neglectus | | | | |
| | 48 | 0% | 0% | 100% |
| | 72 | 0% | 0% | |
| Criconema sp. | 24 | 0% | 0% | 33% |
| | 48 | 0% | 0% | 100% |
| | 72 | 0% | 0% | |
| Pratylenchus sp. | 24 | 0% | 0% | 20% |
| | 48 | 0% | 0% | 100% |
| | 72 | 0% | 0% | |
| Helicotylenchus sp. | 24 | 0% | 0% | 30% |
| | 48 | 0% | 0% | 100% |
| | 72 | 0% | 0% | |
| Tylecnchorhynchus | 24 | 0% | 0% | 30% |
| sp. | 48 | 0% | 0% | 73% |
| | 72 | 0% | 0% | 83% |

It can be clearly observed that both the quillaja saponins (product XC-Ultra) and the non saponin fraction of the extract (product XC-NS), on their own, do not exert a nematicidal effect at the concentration of 100 ppm.

However, in every case, the non-fractionated quillaja extract (product XC-1) had a clear nematicidal effect, particularly against the Meloidogyne and Xiphinema species, which have the greatest phytosanitary importance. This demonstrates the synergy between saponins and the non saponin fraction of the quillaja extract.

### Example 2

### Nematicidal Effect as a Function of Product Dosage

In order to verify the effect of product dosage, experiment were conducted with doses of 1,000 and 10,000 ppm of the products with the Meloidogyne and Xiphinema species, which have the greatest phytosanitary importance.

| | Dose | Time | | | |
|---|---|---|---|---|---|
| Nematode | (ppm) | (h) | XC-Ultra | XC-NS | XC-1 |
| Meloidogyne | 1,000 | 24 | 0% | 0% | 6.6% |
| hapla | ppm | | | | |
| | | 48 | 0% | 0% | 66% |
| | | 72 | 0% | 0% | 100% |
| | 10,000 | 24 | 0% | 10% | 13.3% |
| | ppm | | | | |
| | | 48 | 0% | 30% | 100% |
| | | 72 | 0% | 60% | |
| Xiphinema | 1,000 | 24 | 100% | 50% | 100% |
| index | ppm | | | | |
| | | 48 | | 50% | |
| | | 72 | | 50% | |
| | 10,000 | 24 | 100% | 100% | 100% |
| | ppm | | | | |

### Example

### Nematicidal Effect of Different Formulations

With the object of reducing costs, formulations with a lower concentration of quillaja extract were assayed, such as XC-1 at a concentration of 350 g solids/liter. Mixtures of this product with different percentages of XC-NS were also assessed. The object was to be able to use the highest amount of XC-NS, because its cost is 8-10 times lower than the cost of XC-1.

To this effect, the following products were tested against Meloidogyne halpa and Xiphinema index:
1) XC-1 at 550 g solids/l;
2) XC-1 at a solids concentration of 350 g/l+10% XC-NS at a solids concentration of 350 g/l, prepared with 90% w/w XC-1 and 10% w/w XC-NS;
3) XC-1 at a solids concentration of 350 g/l+15% XC-NS at a solids concentration of 350 g/l, prepared with 85% w/w XC-1 and 15% w/w XC-NS.

The experimental methods were similar to those described in Example 1.

TABLE 2
Mortality percentage of Meloidogyne hapla and Xiphinema
index as a function of the type of product. Dosage: 10,000 ppm.

| Nematode | Product | 12 h | 24 h | 48 h | 72 h |
|---|---|---|---|---|---|
| Meloidogyne hapla | XC-1 @550 g/l | 0% | 20% | 100% | 100% |
| | 90% XC-1 @350 g/l + | 0% | 5% | 20% | 80% |
| | 10% XC-NS @350 g/l | | | | |
| | 85% XC-1 @350 g/l + | 0% | 20% | 60% | 100% |
| | 15% XC-NS @350 g/l | | | | |
| Xiphinema index | XC-1 @550 g/l | 60% | 100% | 100% | 100% |
| | 90% XC-1 @350 g/l + | 10% | 50% | 100% | 100% |
| | 10% XC-NS @350 g/l | | | | |
| | 85% XC-1 @350 g/l + | 20% | 70% | 100% | 100% |
| | 15% XC-NS @350 g/l | | | | |

The experiments show that the product containing 90% XC-1 @350 g/l+10% XC-NS @350 g/l has a slower nematicidal action than the product containing 85% XC-1 @350 g/l+15% XC-NS @350 g/l. However, the product containing 85% XC-1 @350 g/l+15% XC-NS @350 g/l shows a slightly slower nematicidal action than the product containing XC-1 @550 g/l, although within the acceptable ranges. This result implies that it is possible to use the formulation containing 85% XC-1 @350 g/l+15% XC-NS @350 g/l, which has a significant lower cost than that of formulation of XC-1 @550 g/l.

Similar field tests have been conducted with identical results, and even in soils where a high incidence of nematodes was noted to affect the crops, especially in tomatoes in greenhouses, high vigorousness was observed in the plant during its ripening stage once the nematodes had been greatly reduced. Both in tests with tomatoes and in field tests in vineyards, the formulations employed were as described above, in ranges of 20 to 30 liters of product compared with the commercially available chemicals, and higher efficiency was obtained with the application of the products based on quillaja extracts.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. A product for the control of plant parasitic nematodes present in agricultural crops, comprising an aqueous extract from Quillaja saponaria Molina, said extract comprising a saponin fraction with 2 to 14% by weight of said fraction of saponin, and a non saponin fraction with at least 5% of said fraction of polyphenols.

2. A product for the control of nematodes according to claim 1, prepared from quillaja aqueous extract which has a concentration ranging from 100 g solids/liter to 550 g solids/liter, forming a solid fraction containing all soluble solids from quillaja.

3. A product for the control of nematodes according to claim 2, wherein said soluble solids from quillaja are saponins, polyphenols, sugars and salts.

4. A product for the control of nematodes according to claim 1, wherein the non saponin fraction of the quillaja extract has a solids content of approximately 500 g/l to 600 g/l.

5. A product for the control of nematodes according to claim 1, comprising 80% to 90% by weight of a quillaja aqueous extract which contains all the soluble solids of quillaja based on total extract and 10% to 20% by weight of a quillaja aqueous extract which contains only the non saponin fraction, based on total extract.

6. A product for the control of nematodes according to claim 5, wherein the quillaja aqueous extract that contains all the soluble solids of quillaja has a solids concentration of 100 g/l to 550 g/l.

7. A product for the control of nematodes according to claim 1, having a solids concentration of 350 g/l.

8. A method for the control of plant parasitic nematodes, comprising applying an extract of Quillaja saponin Molina.

9. A method for the control of nematodes according to claim 8, wherein said extract comprises a saponin fraction with 2 to 14% by weight of said fraction of saponins and a non saponin fraction with at least 5% by weight of said fraction of polyphenols.

10. A method for the control of nematodes according to claim 8, wherein said extract is applied in a volume of 10 to 40 liters of product per hectare of land.

11. A method for the control of nematodes according to claim 8, wherein said extract is applied in a volume of 25 to 35 liters per hectare.

12. A method for the control of nematodes according to claim 8, wherein said extract is applied through an irrigation system whereby the extract is diluted in irrigation water at a dose of 50 ppm to 10,000 ppm.

13. A method for the control of nematodes according to claim 9, wherein the extract comprises 80% to 90% by weight of a quillaja aqueous extract which contains all the soluble solids of quillaja based on total extract and 10% to 20% by weight of a quillaja aqueous extract which contains only the non saponin fraction, based on total extract.
